(19) United States
(12) Patent Application Publication
(10) Pub. No.: US 2009/0019738 A1
(43) Pub. Date: Jan. 22, 2009

(54) Autograph Board

(76) Inventor: Michael Cunningham, Jackson, NJ (US)

Correspondence Address: FOX ROTHSCHILD LLP, P O BOX 592, 112 NASSAU STREET, PRINCETON, NJ, 08542-0592, US

(21) Appl. No.: 11/779,328

(22) Filed: Jul. 18, 2007

(51) Int. Cl. G09F 11/00

(52) U.S. Cl. 40/1

(57) ABSTRACT

An autograph board includes a transparent pocket for receiving a sports card. A card inserter/extracting tool is employed to insert or extract the card from the pocket in a manner that does minimal damage to the card and prevents finger prints, smudges and the like. The tool preferably includes a ribbed rib section, a long flat shaft and a hook portion that engages the bottom of the card in a slot between the hook section and the shaft. A tapered writing implement holder snaps onto the rib surrounding the autograph board and preferably mimics the shape of the writing implement that might be used, for example, a ball point pen in the shape of a baseball bat. The autograph board can snap into a frame having a triangular peak and a plurality of indentations which are adapted to engage a nail or similar protrusion in the wall.

### CROSS REFERENCE TO RELATED APPLICATIONS

This application is a continuation-in-part and claims the priority of U.S. Provisional Application Ser. No. 60/696,396, filed on Jul. 1, 2005 and entitled “Autograph Board” by Michael Cunningham, and U.S. patent application Ser. No. 11/426,957 filed on Jun. 28, 2006 entitled “Autograph Board” also by Michael Cunningham, the entire contents and substance of which are hereby incorporated in total by reference.

### BACKGROUND OF THE INVENTION

1. Field of the Invention

The invention relates to a board for holding a baseball and uncovering same so that it can be autographed.

2. Description of Related Art

It is increasingly important and usually required for professional and semi-professional athletes to devote a portion of their time to signing autographs for fans.

Prior to this invention a fan would approach a sports athlete and attempt to get an autograph by passing a ball and pen through a group of frantic fans. The athlete must then remove the cap of the pen, awkwardly clutch the pen and ball and attempt a freehand signature on the curved surface. This process usually creates an autograph of poor quality. The athlete must then recap the pen if he remembers what he did with it and attempt to pass the ball and pen back to the same fan. This is frequently a young fan with mustard covered hands. The fan will then attempt to hold the cherished souvenir throughout the sporting event in hands or oiled covered glove. The ball may be dropped on the dirty abrasive concrete or roll down several sections of soda covered rows further blemishing the ball and reducing its quality and value.

Additionally, some athletes and their signatures may not be well known and fans may forget which athlete signed the ball.

Furthermore, upon return home if not immediately placed in a display case the ball can be further exposed to fingerprints, dust, chew marks and loss.

There have been prior art attempts to provide protection for memorabilia such as baseballs and hockey pucks. One is described in US Patent Publication Number US2003/0144094 A1. That publication describes a removable cover for a ball or puck and which includes a window or “autograph opening” through which the athlete can inscribe his or her autograph. A writing implement is attachable to the device by an attachment means. The invention does not appear to provide a support for the ball holder and, in addition, the “autograph opening” means that dust and light can affect the ball over time.

U.S. Pat. No. 6,736,429 describes an invention in which the sports object itself, for example, a simulated basketball, etc., has a pen receiving hole in it attached to the autographable object by a tether. Obviously, the ball is non-functional given the hole therein.

U.S. Pat. No. 5,356,136 is of interest in that it describes another ball and pen combination in which the pen is curved and is attachable to the ball by hook and loop material such as Velcro®.

Japanese Patent JPO 2004 106241A appears to describe another device for holding a ball. A trading card includes a section for writing an autograph and, apparently, a card case also.

U.S. Pat. No. D5,841,878 describes another device for holding a collectable item, for example, a card, with an autograph space and includes multi-media capability, all within a protective housing.

U.S. Design Pat. No. D357,500 describes a combined pen and holder for a sports ball such as a baseball.

U.S. Pat. No. 5,082,110 also describes a case for holding an autograph ball.

Lastly, U.S. Design Pat. No. D498,502 describes yet another device for holding a ball in a display cube.

Insofar as understood, none of the prior art taken individually or in combination describes a baseball holder or holder for a similar item and which can be presented as a whole to an athlete and provides support for the athlete to properly sign the autograph and which thereafter can be mounted on the wall or set on a table or the like in a truly integrated fashion.

### SUMMARY OF THE INVENTION

Briefly described, the invention comprises an autograph board for holding and storing an object such as a baseball or the like so that a quality autograph can be obtained and the object safely stored for posterity. The autograph board comprises primarily a flat board section and a spherical ball cover or protection section. In the case of a baseball, the autograph board itself has a shape suggestive of home plate and evocative of baseball images. The ball itself sits in the center of the board and includes a hemispherical shaped ball receiving section having an interior diameter that is approximately the same as the exterior diameter of the ball it holds. This is important because it prevents the ball from rotating while being autographed by the athlete. A front cover is attached to the board by a hinge and is closable to completely seal the ball in the autograph board device. The invention is symmetrical and has a right and left side palm support area so that the athlete can support his or her hand while autographing the ball which is restrained from rotating by the tight fit in the hemispherical ball receiving means located on the backside of the board. An aperture at the top of the board allows the invention to be carried by a handle. This is especially helpful for young children. The rear surface of the board is equipped with slots that can receive supporting legs so that the autograph board can stand up on a table or flat horizontal surface for display purposes.

According to the preferred embodiment of the invention, the autograph board includes a transparent pocket for receiving a sports card. A card inserter/extracting tool is employed to insert or extract the card from the pocket in a manner that does minimal damage to the card and prevents finger prints, smudges and the like. The tool preferably includes a ribbed rib section, a long flat shaft and a hook portion that engages the bottom of the card in a slot between the hook section and the shaft. A tapered writing implement holder snaps onto the rib surrounding the autograph board and preferably mimics the shape of the writing implement that might be, for example, a ball point pen in the shape of a small baseball bat. The autograph board can snap into a frame having a triangular peak and a plurality of indentations which can engage a nail or similar protrusion on a wall.

These and other features of the invention will be more fully understood by reference to the following drawings.

### BRIEF DESCRIPTION OF THE DRAWINGS

FIG. 1 is a front perspective view of the autograph board according to one embodiment of the invention shown resting on a tabletop.

FIG. 2 is a front elevational view of the autograph according to the embodiment as seen as in FIG. 1.

FIG. 3 is a rear elevational view of the autograph board shown in FIGS. 1 and 2.

FIG. 4 is a top plan view of the autograph board.

FIG. 5 is a bottom plan view of the autograph board.

FIG. 6 is a right side elevational view of the autograph board with detachable legs resting on a horizontal table surface similar to that shown in FIG. 1.

FIG. 7 shows the autograph board being autographed by an athlete wherein the cover has been rotated backwards and the hand of the athlete rest comfortably on the palm support area while the ball is restrained from rotating by its snug fit within the ball receiving cavity.

FIG. 8 illustrates the manner in which the autograph board can be plugged into a shadow box-like frame and hung attractively from a vertical flat surface such as a wall.

FIG. 9 is a perspective view of the preferred embodiment of the Autograph Board according to the invention.

FIG. 10 illustrates the Autograph Board of FIG. 9 including a transparent card holding pocket having a card inserter/extracting tool shown therein.

FIG. 11 illustrates the manner in which the card extracting tool is used to remove a card from the transparent pocket.

FIG. 12A is a detailed view of the transparent pocket and the card inserter/extracting tool shown in an exploded fashion.

FIG. 12B is a cross-sectional view showing a card in the transparent pocket with the tool engaging the lower edge of the card.

FIG. 13 illustrates the manner in which the card inserter/extracting tool is employed to insert a card into the transparent pocket.

FIG. 14 is a perspective view of an alternative embodiment of the writing implement holder.

FIG. 15 is a perspective view of the preferred embodiment of a frame which can accept the Autograph Board so that it can be mounted on a wall in an attractive manner.

FIG. 16 is a back elevational view of the frame shown in FIG. 16 with a back panel attached.

FIG. 17A is also a rear elevational view of the frame invention illustrated in FIG. 16 except with the back panel removed.

FIG. 17B is a detailed cross-sectional view of the manner in which the rib on the Autograph Board pops into a channel in the frame so that the board is held therein in a secure fashion.

### DESCRIPTION OF THE PREFERRED EMBODIMENT

During the course of this description like numbers will be used to identify like elements according to the different figures that illustrate the invention.

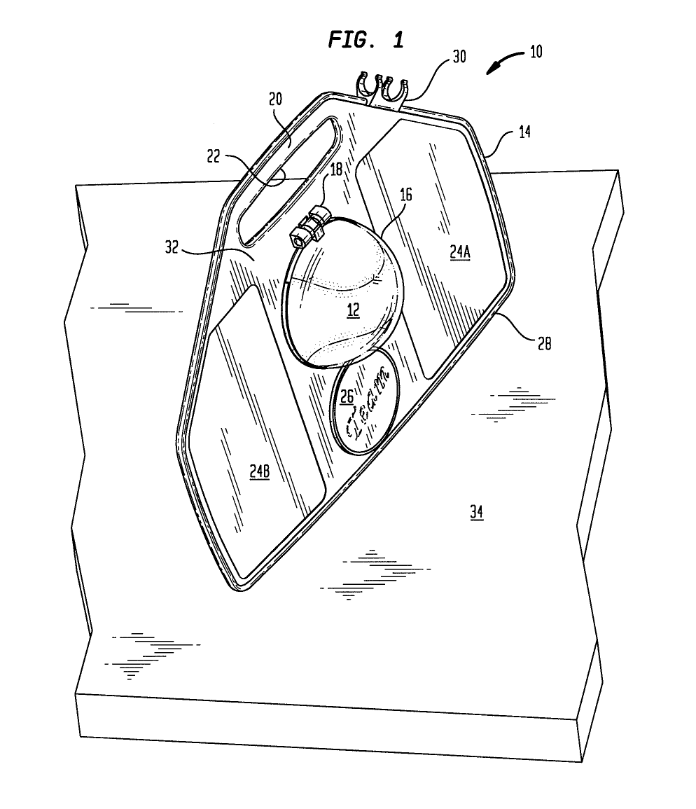

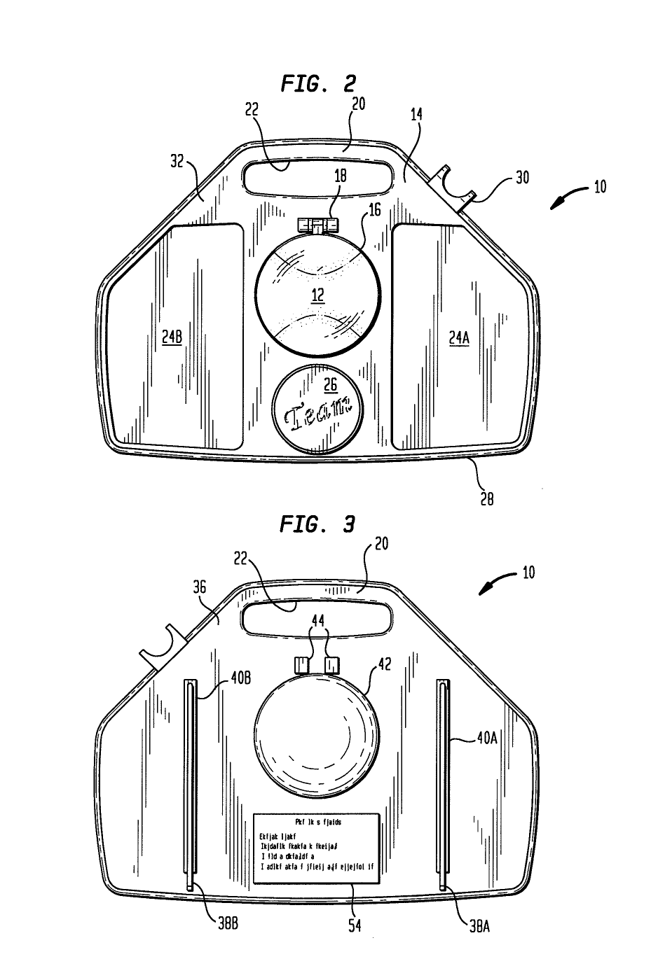

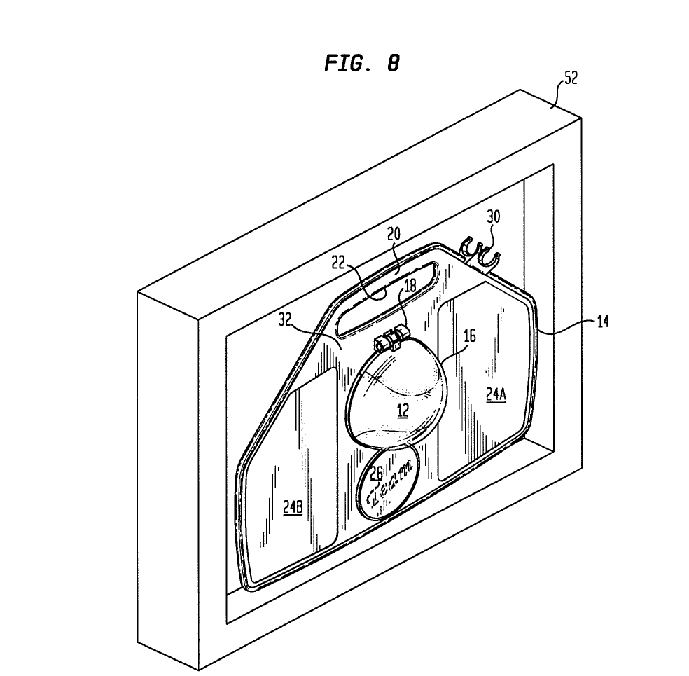

FIG. 1 is a front perspective view of the embodiment of the invention 10 shown resting on a flat horizontal surface 34 such as a table. The invention 10 is intended, in this particular preferred embodiment, to protect a baseball 12 but it could be any other object such as a hockey puck, a tennis ball, softball, etc. The primary parts of the invention 10 comprise a board 14 and a cover16 connected to the board 14 by a hinge 18. A handle section 20 is formed by a handle hole 22 at the top of the board 14. A right palm support area 24A appears to the right of the cover 16 whereas a left palm support area 24B appears on the left of the cover 16. Palm support areas 24A and 24B are intended to support the right and left palm of the athlete signing the ball 12. A team logo area 26 is positioned directly below the cover 16 and is intended for customization. For example, the logo of the New York Yankees, Boston Red Sox, The Chicago Cubs, etc. could be placed at that location. Board 14 includes an edge 28 to which a removable pen clip holder 30 is attachable. Removable pen clip holder 30 is intended to support an ink pen 46 such as shown in FIG. 7. Obviously, the pen 46 could be a baseball bat shaped ball point pen or the like. The idea is that the pen 46 is intended to be indelible and of the sort that would make a long lasting and visible autograph 50 such as also shown in FIG. 7. The elements 12-30 just described are all seen on the front face surface 32 of the invention 10 as illustrated in FIGS. 1 and 2 in particular. Part of the novelty of the invention 10 is that the board 14 is suggestive of the sport being honored. In the case of the invention 10, the board 14 is generally suggestive of home plate. In the case basketball, for example, the board 14 might be circular and in the case of football it might be in the shape of a football. The table surface 34 shown in FIG. 1 could be a table top, a dresser, a shelf or other similar horizontal surface.

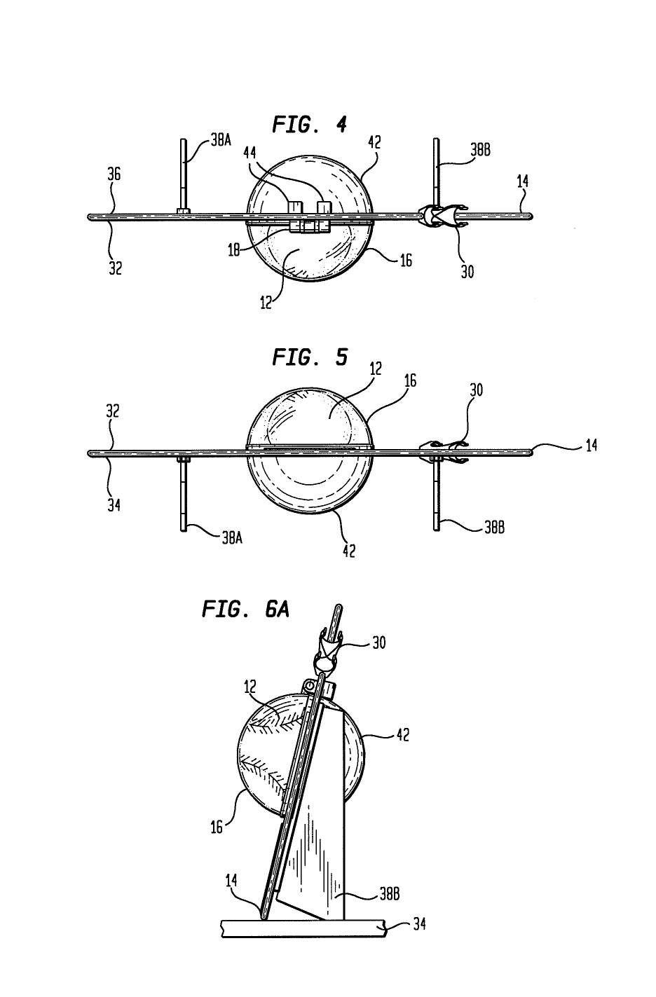

The rear surface 36 of the board 14 is illustrated in FIG. 3. In addition, the invention 10 is seen in a top-plan view in FIG. 4 and in a bottom-plan view in FIG. 5. As seen in FIGS. 3-5, the rear surface includes a pair of selectively attachable right and left frame supports 38A and 38B respectively. Right and left frame supports 38A and 38B are receivable in right and left slots 40A and 40B. The frame supports 38A and 38B might be supplied separately in a package and later inserted into the slots 40A and 40B if needed for support. An important part of the invention 10 comprises the hemisphere shaped ball receiving means 42 located on the rear surface 36 of the board 14. A critical feature of the invention is that the inside diameter of the hemisphere 42 is substantially the same as the outside diameter of the ball 12 so that the ball 12 does not rotate when autographed. Also visible from the rear surface are the back anchors 44 of the hinge 18.

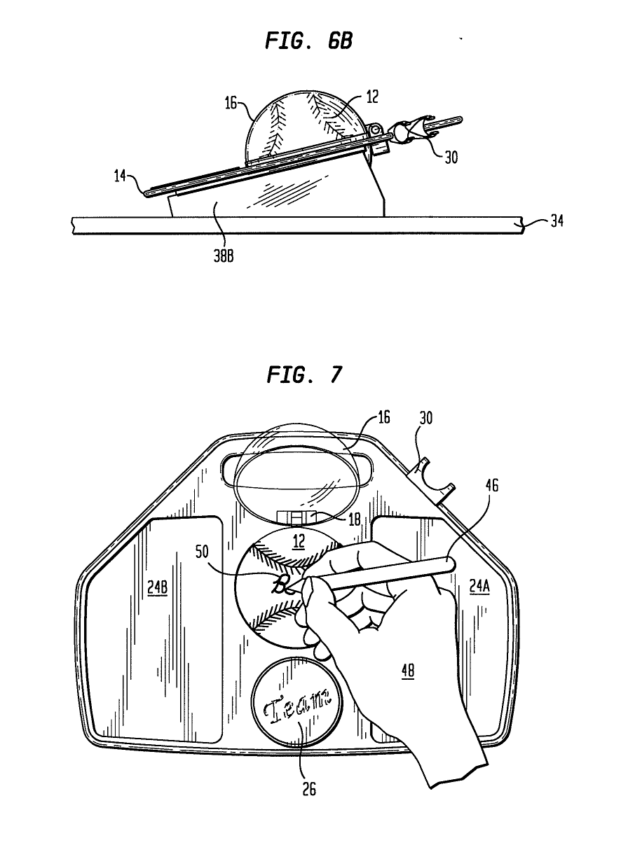

FIG. 6 illustrates the invention 10 in the reclining mode in which the supports 38A and 38B make contact with the horizontal table surface 34.

FIG. 7 illustrates the manner in which the invention 10 is used. First, the autograph seeker hands the apparatus 10 to the athlete who in turn removes the cover 16 revealing the ball 12. Second, the athlete then takes the pen 46 in his or her hand 48 and removes it from clip 30. Third, the athlete rests his or hand 48 on either right or left palm support area 24A and 24B, thereby giving the athlete the optimum support while he or she autographs the ball 12 with an autograph 50 which is optimally legible and done with a pen 46 having indelible, black or blue ink. Fourth, when finished, the athlete gives the invention 10 back to the autograph seeker who permanently closes the cover 16 and replaces the pen 46 in the pen holder clip 30. Fifth, the autograph seeker might then also write in some details of the encounter on the label 54 as shown in FIG. 3. For example, it might read, “Baseball signed by Sammy Slugger on Jun. 18, 2006, when he pitched a no-hitter against the New York Yankees. Witnessed, Alfred Autograph Hunter”.

According to an alternative embodiment illustrated in FIG. 8, the entire invention 10 may be pressed into a deep shadow box type frame 52 and hung on a wall or similar surface.

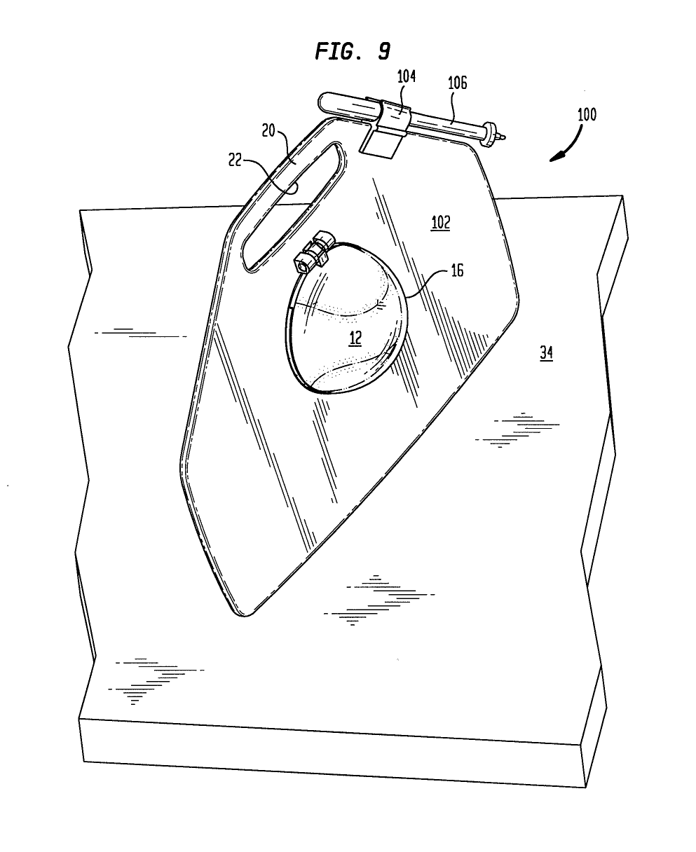

FIG. 9 illustrates the preferred embodiment 100 of the invention shown sitting on a flat surface 34. Like the embodiment 10 illustrated in FIG. 1, the preferred embodiment 100 includes a baseball or similar sports object 12, a transparent shell 16, a handle 20 and an aperture 22. The autograph board 102, however, differs from the autograph board 14 illustrated in FIG. 1, in that it does not include a right and left palm support area 24A and 24B. Instead the surface of autograph board 102 is relatively flat. Also shown attached to autograph board 102 is a writing implement clip 104 and a writing implement 106 such as a ball point pen, having the general shape of a small baseball bat. The clip 104 engages the rib 134 that surrounds the periphery of board 102 in a manner shown in further detail in FIG. 14.

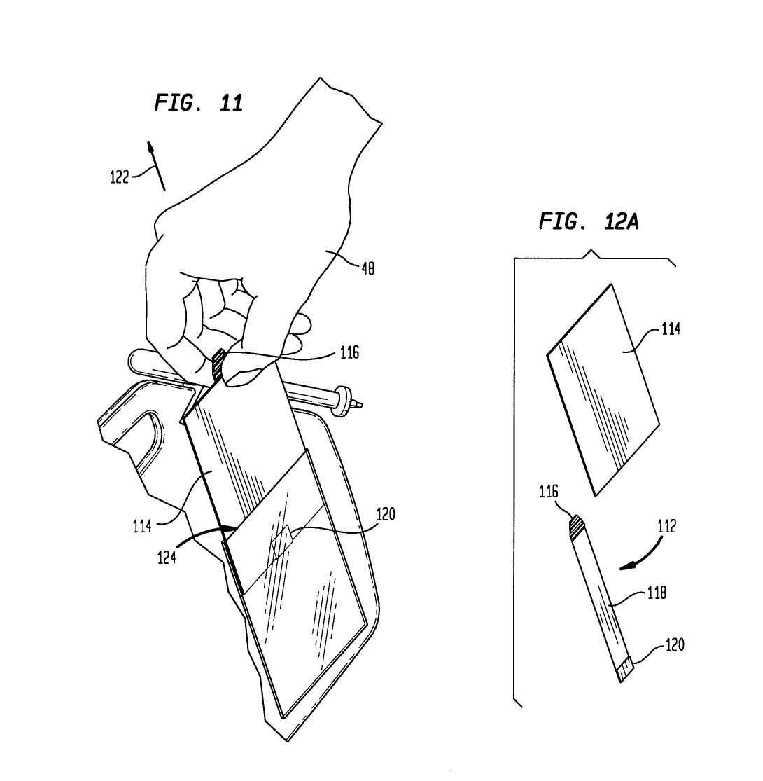

In FIG. 10, the preferred embodiment 100 is shown to include a transparent pocket 110 and a card inserting/extracting tool 112. The card inserting/extracting tool 112 includes a flexible grip section 116 having a plurality of ribs so that it can be easily grasped. A flat shaft is connected at a first end to the grip section 116 and a hook section 120 is attached to the second end of the shaft 118. As seen in FIGS. 12A and 12B, the tool 112 preferably comprises a single piece of transparent material and hook section 120 preferably comprises the same material folded over onto itself so as to form a cavity or card receiving slot therein for engaging the bottom edge of the sports card 114.

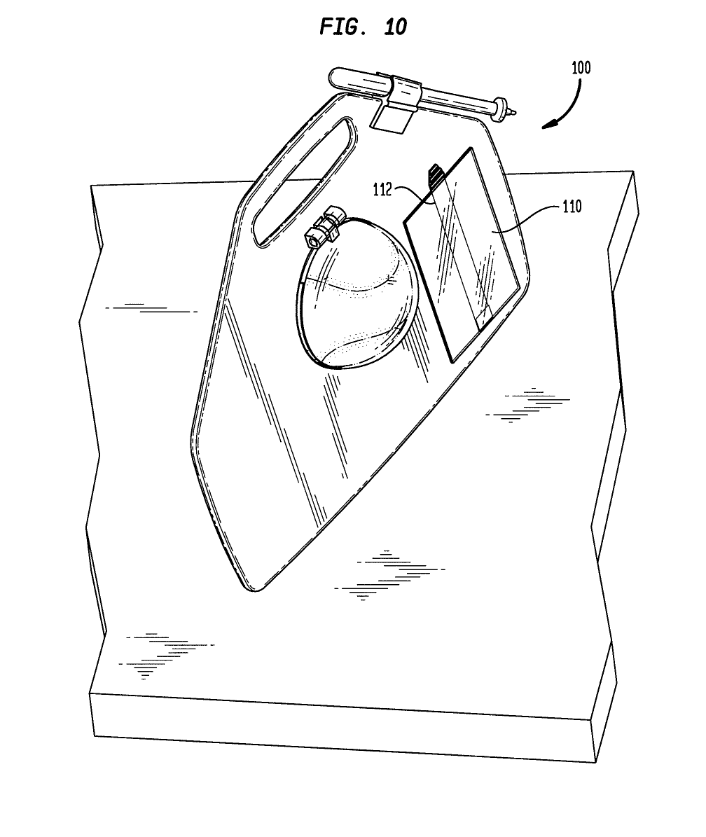

FIG. 11 illustrates the manner in which an individual 48 can use the tool 112 to extract a card 114 from the pocket 110. Initially the card 114 is fully received in pocket 110 as seen in cross-section in FIG. 12B. The user 48 simply grips the flexible tab 116 and pulls it out in the direction of arrow 122 thereby causing the card 114 to withdraw from pocket 110 because its bottom edge is engaged in the slot of hook section 120 of the tool 112. The advantage of tool 112 is apparent in that the user 48 has minimal contact with the graphic surface of card 114. Frequently the card 114 might comprise a baseball card or the like which is autographed by a famous sports figure. In that case it is important that the condition of the card 114 remains pristine and that the individual 48 makes minimal or no contact with the card at any time. The tool 112 helps facilitate this preferred practice.

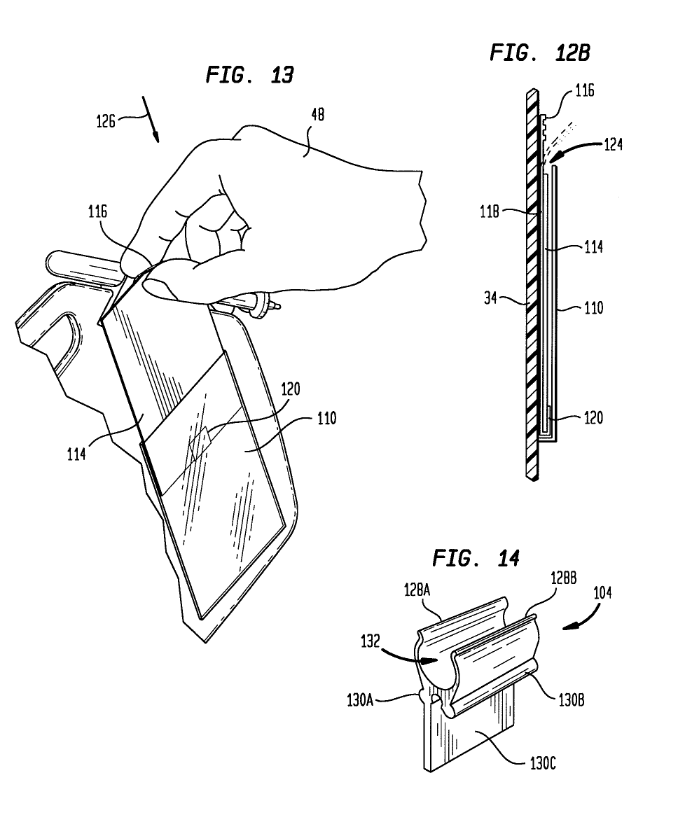

FIG. 13, conversely, illustrates the manner in which the tool 112 is used to insert a card 114 into the pocket 110. The user 48 merely places the card 114 in the slot or grove of the hook section 120 of tool 112 and, using the flexible grip 116, pushes the tool 112 and card 114 into the transparent pocket 110 in the direction of arrow 126. In this manner the user 48 again has minimal contact with the surface of the card 114 thereby insuring the card's lack of contamination or adulteration.

FIG. 14 illustrates the preferred embodiment of a writing implement clip 104 that attaches onto the rib 138 of the board 102 as previously described with regard to FIG. 9. Clip 104 includes a pair of resilient legs 130A and 130B which straddles the rib 134 to hold the clip 104 in place. A resilient leg extension 130C provides the clip 104 with additional stability. Legs 130A and 103B are resilient so that they can snap on and snap off of rib 134 easily. A pair of arms 128A and 128B defines a channel 132 for receiving the writing implement 106 as shown in FIG. 9. Because the writing implement 106 is shown in the form of a small baseball bat, the channel 132 is tapered from front to back so as to provide a snug fit for the writing implement 106. The writing implement 106 may be easily removed from the clip 104 by pulling upward thereon. In this manner the sports figure can sign the card 114 and then the writing implement 106 can be returned to its hold clip 104 for secure storage. Clip 104 is preferably made of a resilient plastic or rubber like material.

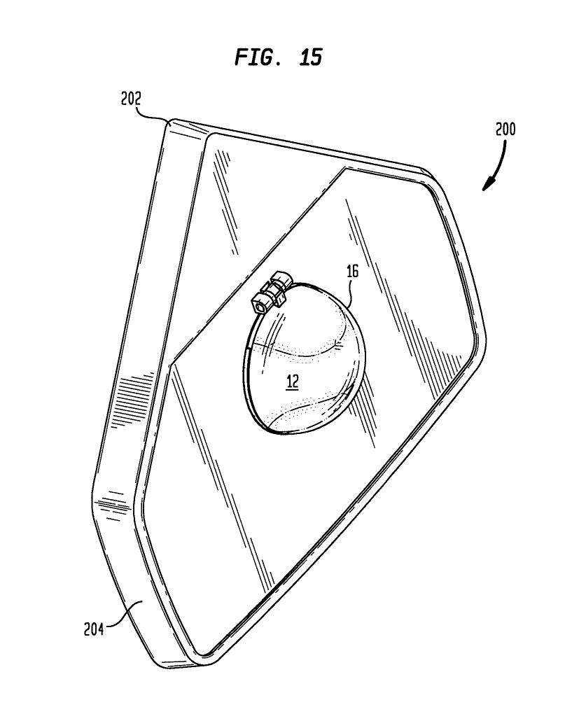

FIG. 15 is a perspective view of the preferred embodiment 200 of a frame device used to mount the autograph board 100 on a wall or similar vertical surface. Frame 200 includes a triangular peak section 202 and a relatively square base section 204.

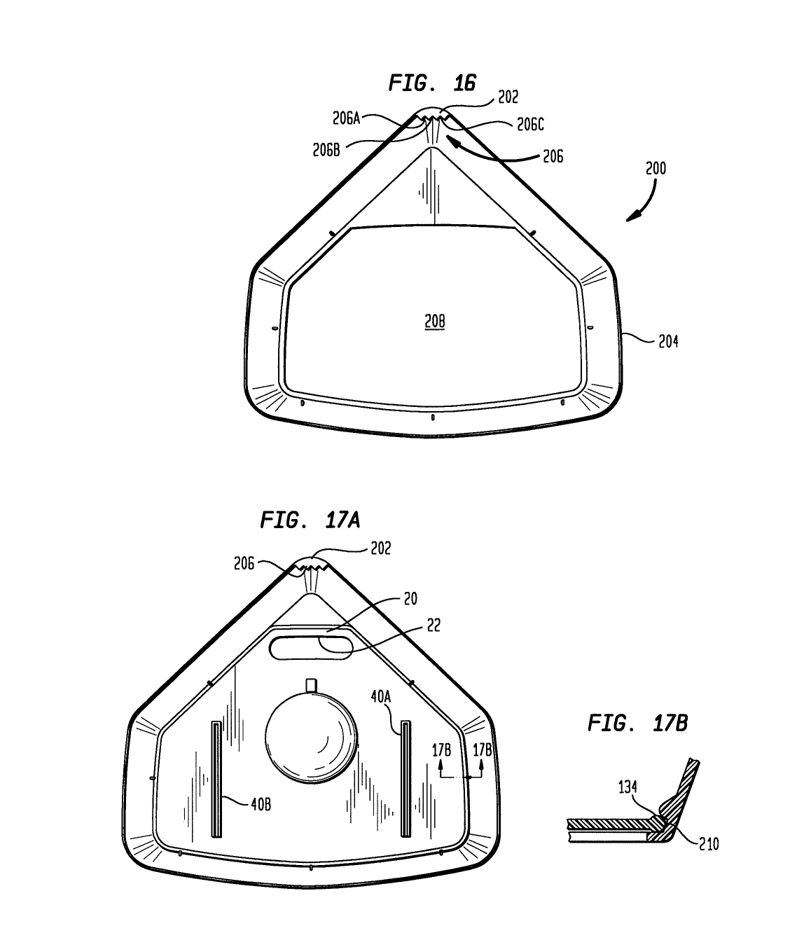

FIG. 16 is a rear elevational view of the preferred embodiment 200 of the frame shown with its back panel 208 attached thereto. The triangular peak 202 of the frame includes a hanger or nail hanging section 206 including a plurality of indentations 206A, 206B and 206C so that the frame 200 can be properly positioned on a nail or the like.

FIG. 17A is also a rear elevational view of the frame 200 similar to that shown in FIG. 16 except with the back panel 208 removed. In this view the handle section 20, aperture 22 and frame stand slots 40A and 40B are visible.

FIG. 17B illustrates the manner in which the rib 136 surrounding the board 200 snaps into a groove 210 in the frame 200. In this manner the board 200 can be easily inserted into the frame 200 and/or removed as necessary. The frame 200 also serves to provide a buffer around the board 100 and to further insure the security of the card 114 and the sports object 12.

In summary, the invention 100 provides a number of advantages over the prior art.

First, it permits a sport card collector safely insert or remove an autographed card from a protective transparent pocket so that the card doesn't get touched or spoiled by fingerprints. The transparent pocket may be made from a UV protective plastic and the board 102 preferably is acid free. Second, the writing implement clip allows the user to hold a pen or the like adjacent to the board where it can be readily remove by the sports figure so that the sports object can be signed. Third, an attractive, wall mountable frame allows the board to be readily snapped in and protected in the back by a panel that keeps dust and contaminants out.

In conclusion, the autograph board 100 invention provides a number of important advantages over the prior art.

While the invention has been described with reference to the preferred embodiment thereof, it will be appreciated by those with ordinary skill in the art that various modifications can be made to the parts that comprise the invention without departing from the spirit and scope of the invention as a whole.

I claim:

1. An autograph board apparatus for holding an object to be autographed, so apparatus comprising:
a board having an aperture with a periphery therein;
an object receiving means attached to said board at the periphery of said aperture for receiving said object;
a cover means attached to said board for covering said object when held in said object receiving means, and,
a substantially transparent pocket on said board for receiving a card,
wherein said card can be viewed through said substantially transparent pocket.

2. The apparatus of claim 1 wherein said pocket has an opening therein for inserting and removing said card.

3. The apparatus of claim 2 further comprising:
a card insertion tool for inserting said card into said pocket.

4. The apparatus of claim 3 wherein said card has a top edge, a bottom edge two side edges and at least one graphic display face and said card inserting tool comprises:
a grip section;
a substantially flat shaft having a first and a second end and wherein said grip section is attached to said first end; and,
a card engaging section located at said second end of said shaft for engaging said bottom edge of said card.

5. The apparatus of claim 4 wherein said card engaging section comprises a folded back portion of said shaft that forms a slot for receiving said bottom edge of said card.

6. The apparatus of claim 5 wherein said object is selected from the group consisting of a baseball, a tennis ball, a hockey puck, a basketball and a football.

7. The apparatus of claim 6 wherein said object is a baseball.

8. The apparatus of claim 7 wherein said card is a baseball card.

9. The apparatus of claim 1 further comprising:
a frame for receiving and mounting said board,
wherein said frame includes a mounting means for mounting said apparatus on a wall.

10. The apparatus of claim 9 wherein said board includes a rib on the periphery thereof and said frame includes a groove therein,
wherein said board can snap into said frame groove for easy mounting.

11. The apparatus of claim 10 wherein said frame has a triangular shaped peak and wherein said frame mounting means includes a plurality of indentations for selectively engaging a mounting protrusion located on said wall.

12. The apparatus of claim 11 further comprising:
a back cover attachable to the back of said frame for covering and protecting the back of said board.

13. The apparatus of claim 1 wherein said board includes a rib around the periphery thereof and said apparatus further includes:
a writing implement holding means having a groove therein for selectively attaching said writing implement holding means to said rib.

14. The apparatus of claim 13 wherein said writing implement holding means includes a rib gripping section and a writing implement holding section having a first and a second sidewall which define a channel for engaging and resiliently holding a writing implement,
Wherein said first and second sidewall hold said writing implement snuggly enough to hold it to said board but loosely enough so that the writing implement can be easily removed by a user.

15. The apparatus of claim 14 wherein said writing implement holding channel is tapered and said writing implement has the shape of a baseball bat,
wherein said tapered channel substantially conforms to the shape of said baseball bat.
